(19) United States
(12) Patent Application Publication
(10) Pub. No.: US 2005/0190401 A1
(43) Pub. Date: Sep. 1, 2005

(54) Communication control method, communication control apparatus, and data recording medium

(76) Inventors: Eiji Ito, Suwa-shi (JP); Toshiharu Katada, Suwa-shi (JP); Toshiyuki Sugimoto, Suwa-shi (JP)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/060,266

(22) Filed: Feb. 17, 2005

(30) Foreign Application Priority Data
Feb. 27, 2004 (JP) 2004-054191

(51) Int. Cl. G06F 3/12; G06F 13/00; G06F 9/44

(52) U.S. Cl. 358/1.15; 710/17; 719/321

(57) ABSTRACT

A communication control method and apparatus quickly confirms the status of a communication port when connecting a peripheral device 2 and an information device 1 through a communication port of the information device 1. The communication control method has a first step in which the second module of the information device 1 creates an object and executes a process to connect the device 2 based on a device connection command from the first module, and then eliminates the object when the connection is no longer needed. A second step confirms if the object was already created when the first module instructs the second module to open a connection to the device 2. A third step determines that the port is closed and the device 2 is not connected if the object is not already created, and instructs the second module to open the port and connect the peripheral device. However, if the object is already created, the third step determines and reports to a higher program level that the port is open and the device 2 is already connected.

### BACKGROUND OF THE INVENTION

1. Field of the Invention

The present invention relates to a communication control method, communication control apparatus, and data recording medium whereby the state of a communication port (input/output port) can be quickly determined.

2. Description of the Related Art

In order to know at a high program level (such as at the application program level or at the level of the external device driver) whether the communication port can be used, that is, whether the port can be opened, in an information device having a communication port to which an external device can be connected, it is conventionally necessary to actually run the process used to open the port. If the process used to open a port is run while the port is being used, an error is returned by the application programming interface (API) of the platform (operating system or middleware), thereby enabling the application or device driver to know that the port is already open and a new connection through the same port cannot be opened.

A problem with this conventional method is that a significant amount of little time is required to actually run and receive a response to the process of opening the communication port.

### SUMMARY OF THE INVENTION

The present invention is thus directed to the foregoing problem, and an object of this invention is to provide a communication control method, communication control apparatus, and data recording medium whereby the current state of a communication port can be quickly determined.

To achieve this object, a communication control method according to the present invention connects a peripheral device and an information device having first and second modules for controlling the peripheral device through a port of the information device. This communication control method comprises steps of: the first module instructing the second module to connect the peripheral device; the second module creating an object indicating that the peripheral device is connected through the port based on an instruction from the first module, opening a connection to the peripheral device, and eliminating the object when the connection is thereafter closed; the first module confirming if the object was already created when the first module instructs the second module to open a connection to the peripheral device; and the first module determining that the port is closed and the peripheral device is not connected, and instructing the second module to open the port and connect the peripheral device, if the object is not already created, and determining and reporting to a higher program level that the port is already open and the peripheral device is already connected if the object was already created.

When attempting to access a peripheral device (also referred to as an external device or simply a “device”), the information device can determine if the peripheral device is already being used by confirming whether the corresponding object was already created and is present. If the object was not created, that is, the communication port is closed and the device is not connected (and thus cannot communicate with the information device), the first module tells the second module to create an object and open a connection to the device. The second module therefore opens the communication port and connects the device (enabling the device and information device to communicate). When the process using the peripheral device ends, the object is then eliminated. If the object was already created, that is, the port is already open and the device is connected, a higher program level object is informed that a new connection to the same device cannot be opened. Because the functions of the first and second modules are separate, directly accessing the device to confirm if communication is possible is not necessary, and whether a connection to the external device can be opened can be quickly determined.

When the second module creates an object, the second module preferably assigns to the object a unique name linking the peripheral device to the specific port. This name, for example, combines the name of the port to which the device is connected (COM1 or COM2, for example) with the name of the device.

The communication control method of the present invention can also be provided as a program causing a computer to execute the steps of the communication control method. More particularly, the communication control method can be provided as a device driver for controlling the device. If the device is a printer, for example, the communication control method can be provided as a printer driver.

More specifically, the present invention also provides a machine readable media embodying a program executable by the machine to execute a function that connects a printer to the machine through a communication port of the computer. This program comprises a step in which a communication control module creates an object indicating that the printer is connected through the port based on a printer connection instruction from a printer module, executes a printer connection process, and eliminates the object when the connection is thereafter closed; and a step in which the printer module confirms if the object was already created when instructing the communication control module to open a connection to the printer, determines that the port is closed and the printer is not connected and instructs the communication control module to open the port and connect the printer if the object is not already created, and determines and reports to a higher program level that the port is already open and the printer is already connected if the object was already created.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a system having a host computer and device;

FIG. 2A and FIG. 2B are system block diagrams describing the operation whereby a device driver opens a communication port;

FIG. 3 is a flow chart illustrating a method whereby the printer module opens a communication port;

FIG. 4 is a flow chart illustrating a method whereby the printer module confirms the port status;

FIG. 5 is a flow chart illustrating a method whereby the communication control module opens a port; and

FIG. 6 is a block diagram of a system according to a second embodiment of the present invention.

### DESCRIPTION OF THE PREFERRED EMBODIMENTS

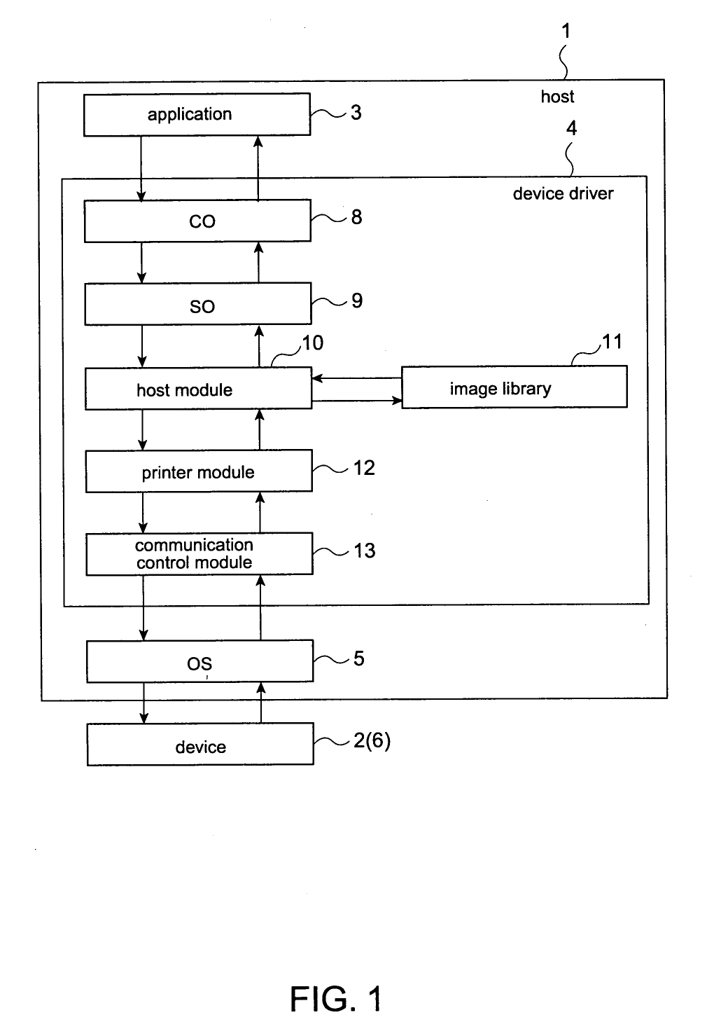

Preferred embodiments of the present invention are described below with reference to the accompanying figures. FIG. 1 is a block diagram of a system in which a device is connected to a host computer.

As shown in FIG. 1, the host 1 has a high level application 3 that runs various processes on the host 1, a device driver 4 for controlling a device 2, and an operating system (OS) 5 providing control of the overall system. The host 1 and device 2 are connected according to a particular data transfer protocol, such as the USB (Universal Serial Bus) interface.

The application 3 could be one or more programs for executing various processes on the host 1. Examples of the application 3 include word processor, spreadsheet, POS receipt generator, and label generator programs.

The device driver 4 includes a control object (CO) 8 and service object (SO) 9. The control object 8 provides the application 3 with a standard interface to various functions (methods), variables (properties), and events. The service object 9 controls the device 2 by way of various modules 10 to 13 and the OS 5.

The device driver 4 opens a communication port and connects the device 2 with a higher program level (application 3) through the opened port. If the port is already open and the device 2 is in use, another port cannot be opened and the application 3 and device 2 cannot be connected.

A method of determining if the port is already open is described next below using a printer as the device 2 by way of example.

In addition to a control object 8 and service object 9, the device driver 4 also has a host module 10, image library 11, printer module 12, and communication control module 13 as shown in FIG. 1.

The host module 10 moderates communication between the application 3, control object 8, service object 9, and other high level objects and the image library 11 and printer module 12.

The image library 11 generates the image data (including text, pictures, and barcodes) specified by the host module 10. For example, the host module 10 receives text data produced by the application 3 and presented in a standard font installed with the OS 5 through the control object 8 and service object 9, and each character in the received text string is generated as a text image in the image library 11. This character image data is sent through the host module 10 to the printer module 12.

The printer module 12 (first module) converts the image data passed from the host module 10 to print data according to the command system supported by the printer 6, and sends the print data to the communication control module 13 (second module). The communication control module 13 then sends the print data to the printer 6. The printer 6 then prints the data.

The communication control module 13 receives and passes status data from the printer 6 to the printer module 12. The printer module 12 interprets the printer 6 status and sends the interpreted result to the host module 10. Based thereon, the host module 10, functioning as a moderator, reports the printer 6 status to the application 3 through the service object 9 and control object 8. The printer 6 status is thus reported to a higher program level (e.g. application 3).

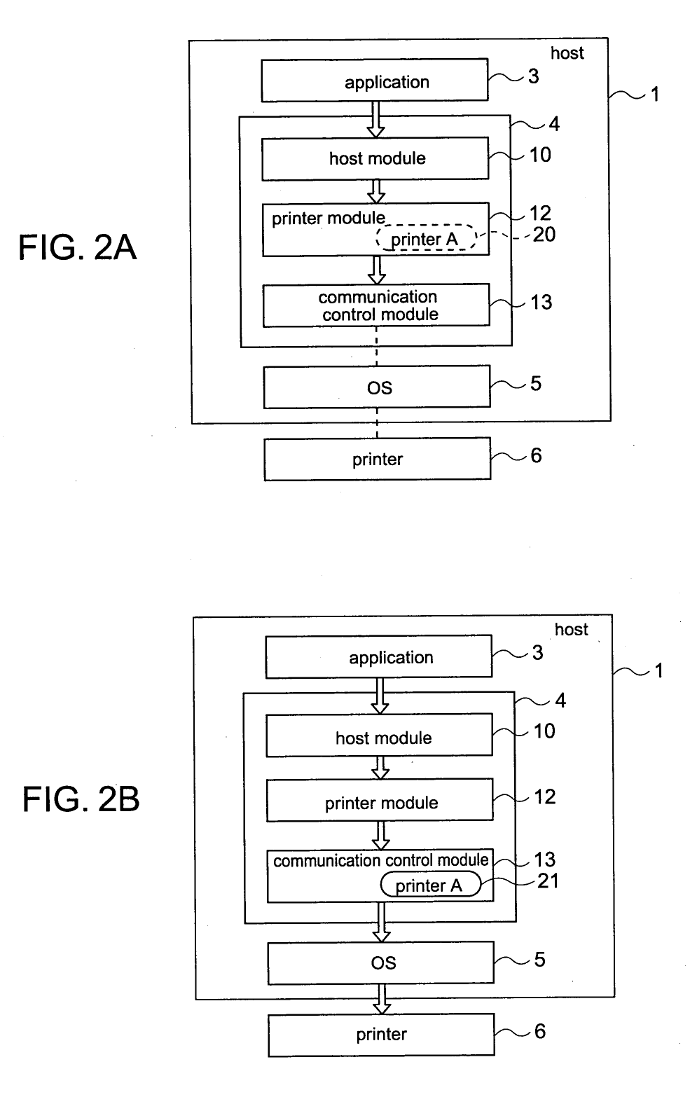

Operation of the device driver 4 when connecting the printer 6 to an application 3 (host 1) or other higher program level is described next below with reference to FIG. 2A and FIG. 2B. Note that the control object 8, service object 9, and image library 11 are omitted in FIG. 2A and FIG. 2B for simplicity.

For the application 3 to print on the printer 6, the application 3 sends a print command and/or print data through the host module 10 to the printer module 12. The printer module 12 instructs the communication control module 13 to open a port, and the communication control module 13 generates a name specifying the designated printer 6 and a corresponding port. This name is called a synchronization object (below simply “object”), such as the object 21 (FIG. 2B) called PRINTER A. The communication control module 13 runs a process for opening a port to connect the printer 6. When use of the connection is completed, the communication control module 13 closes the port and eliminates the object 21.

In this example, the printer module 12 confirms whether the object 21 called PRINTER A already exists in the communication control module 13 to determine the port status before instructing the communication control module 13 to open a port. If as shown in FIG. 2A the corresponding object 21 does not already exist in the communication control module 13, the printer module 12 determines that a port and connection to the printer 6 can be opened, and therefore instructs the communication control module 13 to open a port.

When this command is received, the communication control module 13 creates the object 21 and opens a port as shown in FIG. 2B, thereby connecting the host 1 and printer 6 through the port.

If a connection to the printer 6 is already open and a higher program level object (application 3) attempts to connect to the same printer 6, the printer module 12 can thus determine that the printer 6 is already in use and a port cannot be opened without sending a connection instruction to the communication control module 13 because the object 21 is already present in the communication control module 13.

It will be obvious that while the printer object 20, 21 is called PRINTER A above, the invention shall not be so limited and any name uniquely identifying a communication port to a particular device can be used. Preferably, however, the object 20, 21 name descriptively identifies a particular printer 6 and the port to that printer 6. For example, if the printer 6 is a model DE-F100 manufactured by company ABC, and the corresponding port is COM2, objects 20, 21 could be named “ABC COM2 DE-F100(1).”

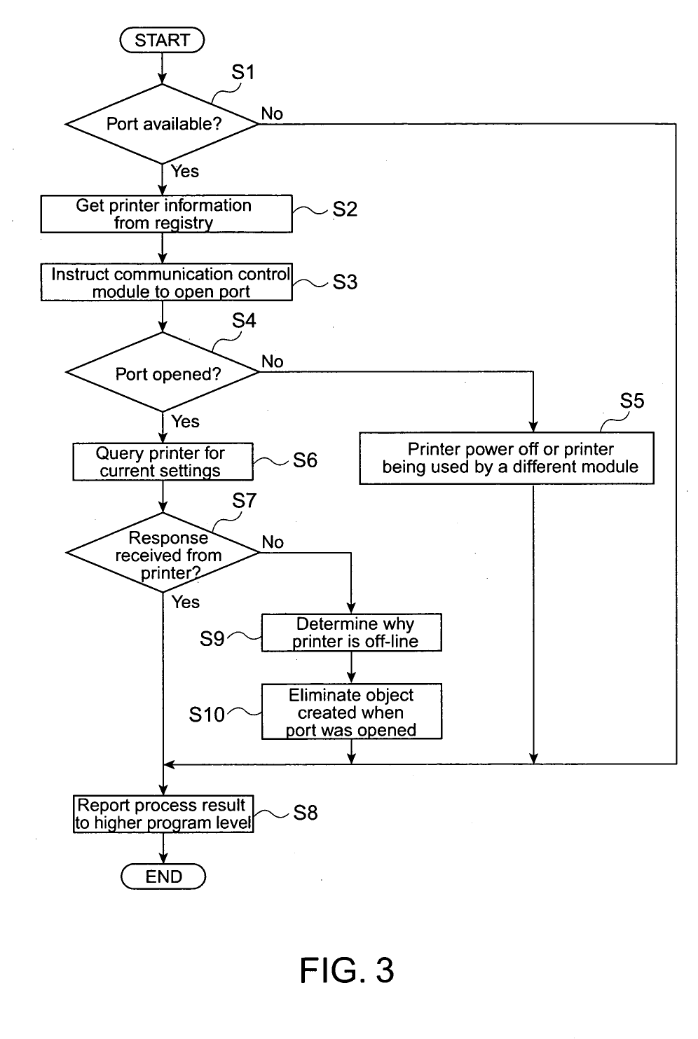

FIG. 3 is a flow chart describing operation of the printer module 12 when opening a communication port. The printer module 12 first determines if the port for connecting to the printer 6 is already in use (S1). If the port is not being used (S1 returns yes), data for the specified printer is acquired from the registry (S2). The OS 5 in this system maintains a registry of information about each connected printer 6. The printer module 12 acquires the information needed to open a port to the printer 6 from this registry based on the printer name (such as DE-F100) passed from the host module 10.

If the port is being used (S1 returns no), the printer module 12 knows and reports to the host module 10 that the printer 6 is already being used (S8). This in-use printer status is also passed through the service object 9 and control object 8 to the higher program level application 3.

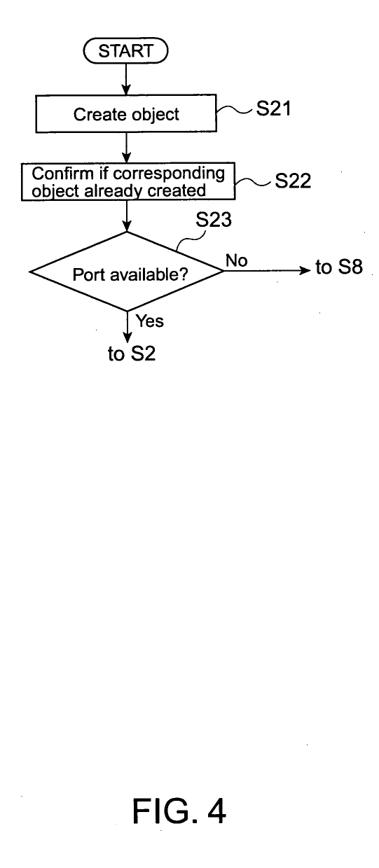

The method whereby the printer module 12 determines in step S1 whether the port is in use or not is described in detail next below with reference to the flow chart in FIG. 4.

The printer module 12 first attempts to create an object 20 with the specified printer name (S21). The object 20 is created by calling an OS 5 function, e.g. named CreateMutex. Whether an object 21 of the same name as the object 20 that the printer module 12 is attempting to create already exists in the communication control module 13 is then determined (S22). This is done by calling an OS 5 function, e.g. named GetLastError, and reading the returned value to determine if the object 21 already exists.

If the GetLastError function is run and the value ERROR_ALREADY_EXISTS is returned (S23 returns no), the printer module 12 knows that the object 21 was already created, the port is already open, and the printer 6 is in use. Control therefore skips to step S8 in FIG. 3, and the result is returned to the higher program level host module 10.

If the GetLastError function is run and the value ERROR_SUCCESS is returned (S23 returns yes), the printer module 12 knows that the object 21 has not yet been created, the port is therefore not open, and the printer 6 is not in use. Control therefore goes to step S2 in FIG. 3.

If the object 21 is present in the communication control module 13, the printer module 12 cannot create a new object of the same name, and can therefore determine that the port is in use.

After acquiring the printer data (S2), the printer module 12 instructs the communication control module 13 to run the process for opening a communication port (S3). Note that the printer module 12 is written to eliminate the previously created object 20 before telling the communication control module 13 to create a new object 21, and the communication control module 13 creates the object 21 in a later process.

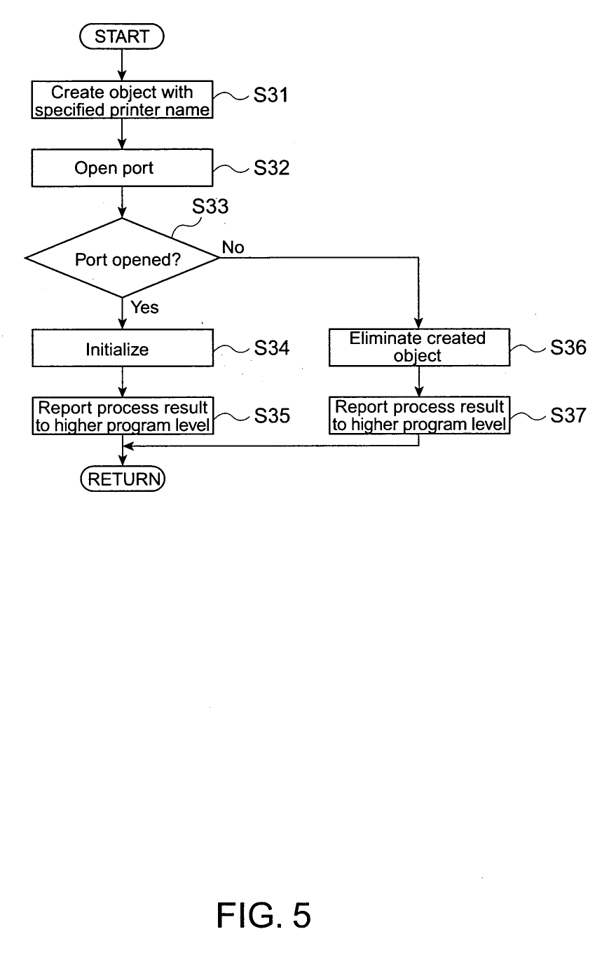

A method whereby the communication control module 13 opens a port when instructed by the printer module 12 is described next with reference to the flow chart in FIG. 5.

When the printer module 12 instructs the communication control module 13 to open a port, the communication control module 13 attempts to create an object 21 of the specified name (S31). This is to confirm whether another high level object (application or driver) created an object of the same name after the printer module 12 eliminated the object 20.

If the object 21 can be created, the communication control module 13 runs the actual process for opening a port using the port name specified by the printer module 12. A port is opened by calling an OS 5 function, e.g. called CreateFile. If a port is successfully opened (S33 returns yes), the port is initialized to enable communication between the printer 6 and communication control module 13 (S34). This initialization process sets the print data communication method, for example. After the port is initialized, the result of the port opening process is returned to the higher program level printer module 12 (S35). If an Error is returned when the CreateFile function is run because a port could not be opened normally (S33 returns no), the created object 21 is eliminated (S36) and the result of the port opening process is returned to the higher program level printer module 12 (S37).

Returning to FIG. 3, the printer module 12 then determines in step S4 if a port was successfully opened based on the result from the communication control module 13 in S36 or S37. If a port was not opened (S4 returns no), the printer module 12 determines that the printer 6 power is off or that another application is using the printer 6 without communication passing through the communication control module 13 (S5), and reports the result to the higher program level host module 10 (S8).

However, if a port was opened (S4 returns yes), the printer module 12 queries the printer 6 for the current settings (S6). These settings include information relating to the printable colors (monochrome, two color, or full color, for example) and the type of recording paper (receipt paper or label paper, for example).

Whether a printer settings response was received from the printer 6 is then determined (S7). If a response is received (S7 returns yes), the printer module 12 knows that the printer 6 can be used, and sends the process result to the host module 10 (S8).

If a printer settings response is not received (S7 returns no), the printer module 12 determines that the printer 6 is off-line. Why the printer 6 is off-line, such as because the printer 6 cover is open, is determined in this situation (S9), and the object 21 created in step S31 is eliminated. This is because the process cannot be completed if the printer is off-line, and this state is effectively the same as being unable to open a communication port. The printer module 12 then reports the result of steps S9 and S10 to the host module 10 (S8).

The result of determining why the printer 6 is off-line is returned to a higher program level as an error code. This error code can be used by the application 3 to, for example, prompt the user to close the printer cover so that the printer 6 goes on-line again and can be used for printing. This prompt can be presented by driving an LED to light steady or blink, presenting a message on a display, or other indication.

When the printer 6 is usable, the communication control module 13 sends the print data and other data from the printer module 12 to the printer 6, and receives and passes printer status data and other data from the printer 6 to the printer module 12. If the communication control module 13 receives a command to close the port from the application 3 through the printer module 12, the communication control module 13 runs an OS 5 function, e.g. called CloseHandle, to close the port and eliminate the object 21.

The present invention thus creates an object 21 in the communication control module 13 when a higher program level object is using a printer, thus enabling the printer module 12 to determine the port status, and thus whether a printer 6 can be used, by confirming whether a corresponding object 21 was already created by the communication control module 13. The port status can thus be quickly determined without actually running the process of opening a port.

Furthermore, because the port status can be confirmed without accessing the printer 6, the connection status of various types of printers 6 can be easily confirmed regardless of the type of port (USB or COM, for example) used for communication, that is, regardless of how a port is opened for communication with the printer 6.

A system in which two printers 6a, 6b are connected to the host 1 and two applications 3a, 3b are run simultaneously on the host 1 is described next below according to a second embodiment of the invention.

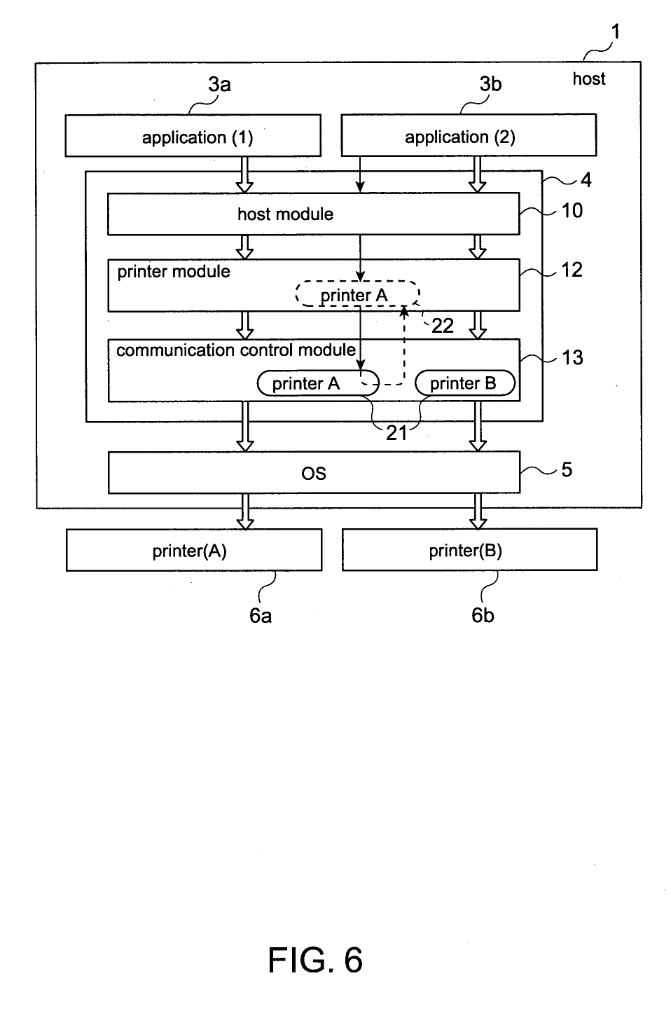

FIG. 6 is a block diagram of a system according to this second embodiment of the invention. This embodiment differs from the first embodiment shown in FIG. 2A and FIG. 2B only in the number of applications 3 and printers 6. Like parts are therefore referenced by the same reference numerals, and further description thereof is omitted below.

This example assumes that application 3a is already connected to printer A 6a (that is, the port to which printer A 6a is connected was previously opened by application 3a) as described above with reference to FIG. 2B, and object 21 (PRINTER A) was created in the communication control module 13. Operation when another application 3b then tries to print to the same printer A 6a is described below.

When another application 3b thus tries to print to the same printer A 6a, the printer module 12 instructs the communication control module 13 to open a connection to the printer A 6a, and the communication control module 13 tries to create an object 22 corresponding to the printer A 6a. Because the name of the object 22 corresponds to the printer A 6a, the name of this object is the same as the name of object 21, that is, PRINTER A (S21). The printer module 12 then determines if an object of the same name was already created in the communication control module 13 (S22). Because the communication control module 13 already created an object 21 of the same name, the printer module 12 knows that the port is already open and printer A 6a is in use (S23).

Operation when the application 3b attempts to print using the other printer (B) 6b is described next.

The printer module 12 first tries to create an object named PRINTER B (S21), and confirms if the communication control module 13 already created an object of the same name “PRINTER B” (S22). Because an object named PRINTER B is not present in the communication control module 13, the printer module 12 can create the PRINTER B object, knows that the port is not open, and that printer B 6b is not being used (S23). A connection is then made to printer B 6b as shown from step S2 in FIG. 3 and described above.

A separate object 21 is thus created for each printer 6 when multiple printers are connected to the host 1, thereby enabling separately determining the connection status of each printer. The connection status of each printer can also be confirmed using the same method regardless of how the printers are connected, that is, using a USB, wireless, or other communication interface.

The device 2 shall not be limited to a printer 6, and could be any device that is connected through a port of an information device, including a disk drive, scanner, and communication terminal.

The names of the objects 20 to 22 shall also not be limited to a name linking a printer 6 to a specific port. For example, the object name could link a printer 6 to the version of the communication control module 13, or a printer 6 to the name of the control system.

The object 20 for confirming whether a port is being used and the object 21 for actually opening a port can be differently named insofar as object 21 is named to include object 20.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. A communication control method for connecting a peripheral device and an information device having first and second modules for controlling the peripheral device through a port of the information device, the communication control method comprising steps of:
the first module instructing the second module to connect the peripheral device;
the second module creating an object indicating that the peripheral device is connected through the port based on an instruction from the first module, opening a connection to the peripheral device, and eliminating the object when the connection is thereafter closed;
the first module confirming if the object was already created when the first module instructs the second module to open a connection to the peripheral device; and
the first module determining that the port is closed and the peripheral device is not connected, and instructing the second module to open the port and connect the peripheral device, if the object is not already created, and
determining and reporting to a higher program level that the port is already open and the peripheral device is already connected if the object was already created.

2. The method of claim 1, wherein when the second module creates an object, the second module assigns to the object a unique name linking the peripheral device to the specific port.

3. A communication control method for connecting a printer and an information device having first and second modules for controlling the printer through a port of the information device, the communication control method comprising steps of:
the first module instructing the second module to connect the printer;
the second module creating an object indicating that the printer is connected through the port based on an instruction from the first module, opening a connection to the printer, and eliminating the object when the connection is thereafter closed;
the first module confirming if the object was already created when the first module instructs the second module to open a connection to the printer; and
the first module determining that the port is closed and the printer is not connected, and instructing the second module to open the port and connect the printer, if the object is not already created, and
determining and reporting to a higher program level that the port is already open and the printer is already connected if the object was already created.

4. A communication control apparatus for connecting a printer and an information device controlling the printer through a port of the information device, wherein the communication control apparatus is included in the information device and comprises:
a communication control module that creates an object indicating that the printer is connected through the port based on a printer connection instruction from a printer module, executes a printer connection process, and eliminates the object when the connection is thereafter closed; and
the printer module confirms if the object was already created when instructing the communication control module to open a connection to the printer,
determines that the port is closed and the printer is not connected, and instructing the communication control module to open the port and connect the printer, if the object is not already created, and
determines and reports to a higher program level that the port is already open and the printer is already connected if the object was already created.

5. A medium readable by a machine embodying a program of instructions executable by the machine to cause the machine to function as a first module and a second module for connecting the machine and a printer through a port of the machine by executing the steps of:
the first module instructing the second module to connect the printer;
the second module creating an object indicating that the printer is connected through the port based on an instruction from the first module, executing a printer connection process, and eliminating the object when the connection is thereafter closed;
the first module confirming if the object was already created when the first module instructs the second module to open a connection to the printer; and
the first module determining that the port is closed and the printer is not connected, and instructing the second module to open the port and connect the printer, if the object is not already created, and
determining and reporting to a higher program level that the port is already open and the printer is already connected if the object was already created.
